(19) United States
(12) Patent Application Publication
(10) Pub. No.: US 2011/0103355 A1
(43) Pub. Date: May 5, 2011

(54) PACKET GROUPING FOR A CO-EXISTING WIRELESS NETWORK ENVIRONMENT

(75) Inventors: Yanjun SUN, Richardson, TX (US); Ariton E. XHAFA, Plano, TX (US); Assaf SELLA, Rishpon (IL); Josef PEERY, Ra'anana (IL); Xiaolin LU, Plano, TX (US)

(73) Assignee: TEXAS INSTRUMENTS INCORPORATED, Dallas, TX (US)

(21) Appl. No.: 12/913,333

(22) Filed: Oct. 27, 2010

Related U.S. Application Data
(60) Provisional application No. 61/256,536, filed on Oct. 30, 2009.

(51) Int. Cl. H04W 4/00; H04W 84/02

(52) U.S. Cl. 370/338; 370/328

(57) ABSTRACT

In at least some embodiments, a communication device includes a host processor and a plurality of co-existing wireless technology transceivers coupled to the host processor. The plurality of co-existing wireless technology transceivers share a communication medium using time-multiplexing. A throughput for data transmissions by the plurality of co-existing wireless technology transceivers is based on an algorithm that determines a grouping option for data packets to be transmitted by one of the co-existing wireless technology transceivers, the grouping option providing a highest throughput for a predetermined baseband PHY rate without exceeding a predetermined maximum grouping delay.

### CROSS-REFERENCE TO RELATED APPLICATIONS

This application claims priority to provisional application No. 61/256,536 filed Oct. 30, 2009 and entitled “Using Optimum Packet Grouping For Bluetooth In Coexisting Wireless Networks”. This priority document is hereby incorporated herein by reference as if reproduced in its entirety.

### BACKGROUND

Next generation mobile devices implement a plurality of wireless technologies to access different networks such as WiMAX networks, WLAN networks, LTE networks, Wireless USB or Bluetooth (BT) networks, etc. Such devices are referred to herein as “combo” devices. While increased access to these technologies benefit users and operators alike, interference among different technologies, particularly onboard a single combo device, introduces difficulties during concurrent operation of these technologies. For example, and as illustrated in FIG. 1, WLAN (in 2.4-2.5 GHz) and WiMAX (2.3-2.4 GHz and 2.5-2.7 GHz) technologies operate at relatively close frequency bands with respect to each other—so close, in fact, that the out-of-band emission by either technology may saturate the receiver of the other technology resulting in potential blocking. Thus, the interference between different technologies operating in the same combo device creates coexistence problems. FIG. 1 shows different technologies and their operating bands. Co-existence of different technologies in the same device via time multiplexing can result in inefficient use of the medium by one technology, indirectly impacting the performance of the other technology.

### SUMMARY

In at least some embodiments, a communication device includes a host processor and a plurality of co-existing wireless technology transceivers coupled to the host processor. The plurality of co-existing wireless technology transceivers share a communication medium using time-multiplexing. A throughput for data transmissions by the plurality of co-existing wireless technology transceivers is based on an algorithm that determines a grouping option for data packets to be transmitted by one of the co-existing wireless technology transceivers, the grouping option providing a highest throughput for a predetermined baseband PHY rate without exceeding a predetermined maximum grouping delay.

In accordance with at least some embodiments, a transceiver includes receiving logic configured to receive data packets from a data source and re-grouping logic configured to re-group the received data packets for output to a data sink. The re-grouping logic determines a grouping option that provides a highest throughput for a predetermined baseband PHY rate without exceeding a predetermined latency threshold for the data sink.

In accordance with at least some embodiments, a method includes receiving, by a processor, data packets from a data source. The method also includes grouping, by the processor, the received data packets for output to a data sink. The grouping step includes determining a grouping option that provides a highest throughput for a predetermined baseband PHY rate without exceeding a predetermined latency threshold for the data sink.

### BRIEF DESCRIPTION OF THE DRAWINGS

For a detailed description of exemplary embodiments of the invention, reference will now be made to the accompanying drawings in which:

FIG. 1 illustrates different network technologies and their operating bands;

FIG. 2 illustrates a system in accordance with an embodiment of the disclosure;

FIG. 3 illustrates a packet grouping comparison timeline in accordance with an embodiment of the disclosure;

FIG. 4 illustrates a protocol model in accordance with an embodiment of the disclosure;

FIG. 5 illustrates a block diagram of data streaming procedures and packet format layering in accordance with the protocol model of FIG. 4;

FIG. 6 illustrates a data streaming set up diagram in accordance with an embodiment of the disclosure;

FIG. 7 illustrates a wireless local area network (WLAN) in accordance with an embodiment of the disclosure;

FIG. 8 illustrates an exemplary general-purpose computer system that perform packet grouping in accordance an embodiment of the disclosure;

FIG. 9 illustrates a simplified communication device in accordance with an embodiment of the disclosure; and

FIG. 10 illustrates a method in accordance with an embodiment of the disclosure.

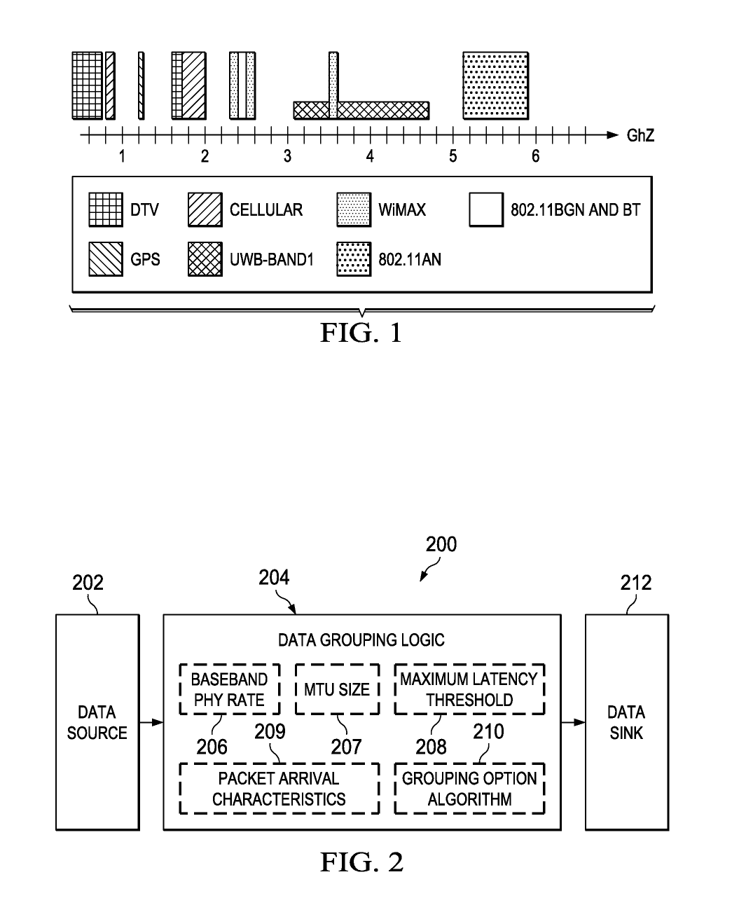

### DETAILED DESCRIPTION

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices or a sub-system thereof. Further, the term “software” includes any executable code capable of running on a processor, regardless of the media used to store the software. Thus, code stored in non-volatile memory, and sometimes referred to as “embedded firmware,” is included within the definition of software.

Embodiments of the invention are directed to grouping or re-grouping data packets received from a data source for output to a data sink. The grouping or re-grouping operation determines which of a plurality of grouping options provides a highest throughput for a predetermined baseband PHY rate without exceeding a predetermined maximum grouping delay. In at least some embodiments, the predetermined maximum grouping delay depends, at least is part, on a maximum latency threshold for the data sink. The grouping or re-grouping operation is performed, for example, by a host processor or a transceiver of a communication device with co-existing wireless technologies that share a communication medium using time-multiplexing. For such communication devices, the grouping or re-grouping operation optimizes throughput for a given co-existing wireless technology and thereby enables at least one other co-existing wireless technology to receive a larger time window for its communications.

FIG. 2 illustrates a system 200 in accordance with an embodiment of the disclosure. As shown in FIG. 2, the system 200 comprises a data source 202 coupled to a data sink 212 via data grouping logic 204. The data grouping logic 204 operates on data packets received from the data source 202 in a manner that improves the efficiency of transferring data from the data source 202 to the data sink 212. The data grouping logic 204 may correspond to, for example, a host processor or a transceiver processor configured to group or re-group data packets in transit from the data source 202 to the data sink 212. The grouping or re-grouping operation ensures high-efficiency data transmission while maintaining compatibility with a wireless communication protocol (e.g., Bluetooth®). In at least some embodiments, the data grouping logic 204 is part of a communication device with a plurality of co-existing wireless technologies, where the grouping operation of the data grouping logic 204 enables at least one other co-existing wireless technology (e.g., WLAN) to receive more time for communications in a time-multiplexed environment.

In at least some embodiments, the data grouping logic 204 determines a grouping option for received data packets in accordance with parameters such as a baseband PHY rate 206, a maximum latency threshold 208 and a Maximum Transmission Unit (MTU) size 207. Further, packet arrival characteristics 209 such as distribution of packet size and arrival interval may be used to determine the grouping option.

The baseband PHY rate 204, the maximum latency threshold 208, the MTU size 207 and the packet arrival characteristics 209 may vary for different applications. For example, the baseband PHY rate 204 may correspond to a particular wireless technology (e.g., Bluetooth®) and/or a desired data streaming performance. Similarly, the maximum latency threshold 208 may correspond to a particular data sink (e.g., speakers) and/or a desired data sink throughput. The MTU size 207 may vary for different host devices or radio transceivers. The packet arrival characteristics may vary for different data sources 202.

In at least some embodiments, the grouping logic 204 employs a grouping option algorithm 210 that determines a grouping option for data packets in transit to the data sink 212. The determined grouping option provides a highest throughput for the predetermined baseband PHY rate 206, the MTU size 207, and packet arrival characteristics 209 without exceeding the maximum latency threshold 208. If data packets are already grouped by the data source 202 for transmission to the data sink 212, the data grouping logic 204 enables a non-optimized grouping of data packets to be replaced with an optimized grouping of data packets for transmission to the data sink 212. Again, the optimization improves efficiency of data transmission while maintaining compatibility with a wireless communication protocol in an environment with a plurality of co-existing wireless technologies.

In embodiments where the data grouping logic 204 is part of a host processor, the host processor outputs optimized groupings of data packets in accordance with the grouping option algorithm 210. As an example, the optimized groupings of data packets may be provided to one of a plurality the co-existing wireless technology transceivers for transmission to the data sink 212. Alternatively, in embodiments where the data grouping logic 204 is part of a co-existing wireless technology transceiver, the co-existing wireless technology transceiver that executes the grouping option algorithm 210 is configured to receive non-optimized groupings of data packets from a host processor to re-group the data packets in accordance with the grouping option algorithm 210.

As re-grouping packets is often a costly process due to the disassembly, buffering and re-assembly overhead involved, such re-grouping should only be used if the re-grouping benefits outweigh the re-grouping overhead. So some measure is needed to determine when to implement the re-grouping process. For A2DP traffic, once a packet size is given, throughput can be determined for the current baseband PHY rate and MTU size. Accordingly, the received packet size may be used as the measure to determine whether re-grouping is necessary. As an example, if the received packet size is determined to be the same as the resulting packet size after the re-grouping algorithm is applied, then the re-grouping process is bypassed. Even if the received packet size and the resulting packet size are different, if the throughput gain is marginal, the re-grouping process may be bypassed to avoid the re-grouping overhead.

In at least some embodiments, the grouping option algorithm 210 causes the data grouping logic 204 to access a look-up-table (LUT). When SBC frames are grouped for A2DP traffic over Bluetooth, for example, an entry in LUT contains elements such as baseband PHY rate (1, 2 or 3 Mbps), MTU size, SBC frame size and maximum grouping latency. Another element in this entry will be the desired number of SBC frames to be grouped together. This information can be stored, for example, in a memory (e.g., flash memory, hard disk, etc.) of the host device of the radio transceiver. Alternatively, the grouping option algorithm 210 causes the data grouping logic 204 to perform a polynomial search to determine which of a plurality of grouping options for received data packets provides the highest throughput given the baseband PHY rate 206, the MTU size 207, the packet arrival characteristics 209 and the maximum latency threshold 208. In the polynomial search, all possible numbers for grouping are enumerated and the grouping option that yields the highest throughput is determined. The space of enumeration is often very limited as it has to be positive and it is bound by system limitations such as the MTU of the host device (or that of peer node) and the maximum grouping delay (latency) allowed.

In pseudo code, the polynomial search for A2DP traffic operates as follows:
line 1: let n=1, output=0, max_throughput=0
line 2: let n=n+1
line 3: if grouping n SBC frames would result in a packet size greater than minimum MTU, terminate the search and use output
line 4: if grouping n SBC frames would result in longer SBC frame delivery latency than that latency that can be tolerated by the peer node (the data sink), terminate the search and use output
line 5: suppose tmp_throughput would be the resulting throughput with the current baseband rate if n packets are grouped together, if tmp_throughput is greater than max throughput, let output=n, maxthroughput=tmpthroughput
line 6: go back to line 2

Although other applications are possible, the data grouping logic 204 may be applied to A2DP traffic output by a host processor for transmission by one of a plurality of co-existing wireless technology transceivers. In such case, the grouping option algorithm 210 determines a maximum number of low complexity sub-band codec (SBC) frames to package into an L2CAP frame without exceeding the maximum latency threshold 208.

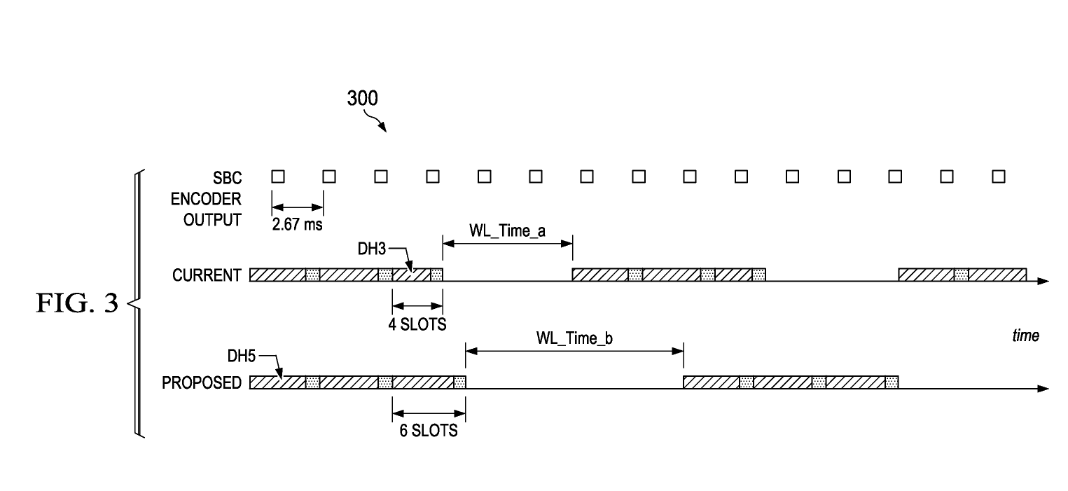

FIG. 3 illustrates a packet grouping comparison timeline 300 in accordance with an embodiment of the disclosure. In the timeline 300, an SBC encoder output is shown. The timeline 300 also shows a current scheme and a proposed scheme for grouping A2DP traffic in a time-multiplexed environment. The timeline 300 of FIG. 3 illustrates the effect of grouping packets efficiently into BT baseband frames (as shown in the proposed scheme) to minimize communication medium time allocated to BT. In this way, the communication medium time available to WLAN is increased (and thus the throughput of WLAN is increased).

There are many opportunities to group packets more efficiently into BT baseband frames. As an example, A2DP traffic is composed of a sequence of SBC frames with is known from Bluetooth® standards. When two BT nodes set up a connection, a maximum L2CAP size for transmission of A2DP traffic is negotiated. The A2DP traffic is then prepared for transmission by grouping as many SBC frames into a L2CAP frame as possible. This L2CAP frame is then passed to the baseband layer and is segmented into pieces that a baseband frame can hold for delivery. Inefficiencies arise in the above example when the capacity of a baseband frame is underutilized (e.g., due to the capacity of baseband frames not being considered during the SBC grouping).

In accordance with preliminary research, A2DP traffic can be transmitted at 707 Bytes/16 ms with 6 SBC frames in a L2CAP frame. If the basic rate of BT is used, this amount of A2DP traffic results in 2 DH5 frame transmissions plus a DH3 frame transmission as shown in the current scheme of FIG. 3. The problem with the current scheme is that the DH3 frame only carries 29 bytes, even though it can carry up to 121 bytes. On average, the medium time available for WLAN (WL_Time_a) in the current scheme is 375 ms per second.

On the other hand, for the proposed scheme, the capacity of each baseband frame is filled as much as possible by choosing a frame type that provides higher throughput. In the proposed scheme of FIG. 3, 8 SBC frames are included in one L2CAP frame. In such case, 3 DH5 frame transmissions are needed to deliver the L2CAP frame as illustrated in FIG. 3. In this case, the medium time available for WLAN (WL_Time_b in FIG. 3) is 473 ms per second. This increased communication medium time for WLAN results result in at least a 25% gain in WLAN throughput.

For the proposed scheme of FIG. 3, a grouping option algorithm (e.g., grouping option algorithm 210) is employed to find the optimal configuration for grouping the SBC frames. For example, suppose a data sink allows a maximum delay of 25 ms for SBC grouping. In such case, the grouping option algorithm enumerates all possible SBC grouping options to find out which one provides the highest throughput given the baseband PHY rate (i.e., 1 SBC in a L2CAP, 2 SBCs in a L2CAP and so on) as long as the maximum delay of 25 ms is not reached. This is simply a polynomial search and can be performed in a timely fashion even with an embedded processor. Alternatively, an LUT with grouping option information may be accessed to determine a grouping option for a particular scenario.

The proposed scheme of FIG. 3 applies to a communication device with WLAN and BT transceivers. The proposed scheme attempts to minimize the communication medium time needed for BT transmissions and thus increases the communication medium time available to for WLAN transmissions. For a common configuration of BT A2DP traffic and backlogged WLAN FTP traffic in a communication device with co-existing WLAN and BT transceivers, the proposed scheme improves WLAN throughput by approximately 25% without sacrificing QoS nor the throughput of A2DP traffic. Although FIG. 3 illustrates applying a grouping option algorithm to A2DP traffic, it should be understood that the grouping of other BT frames is possible as well.

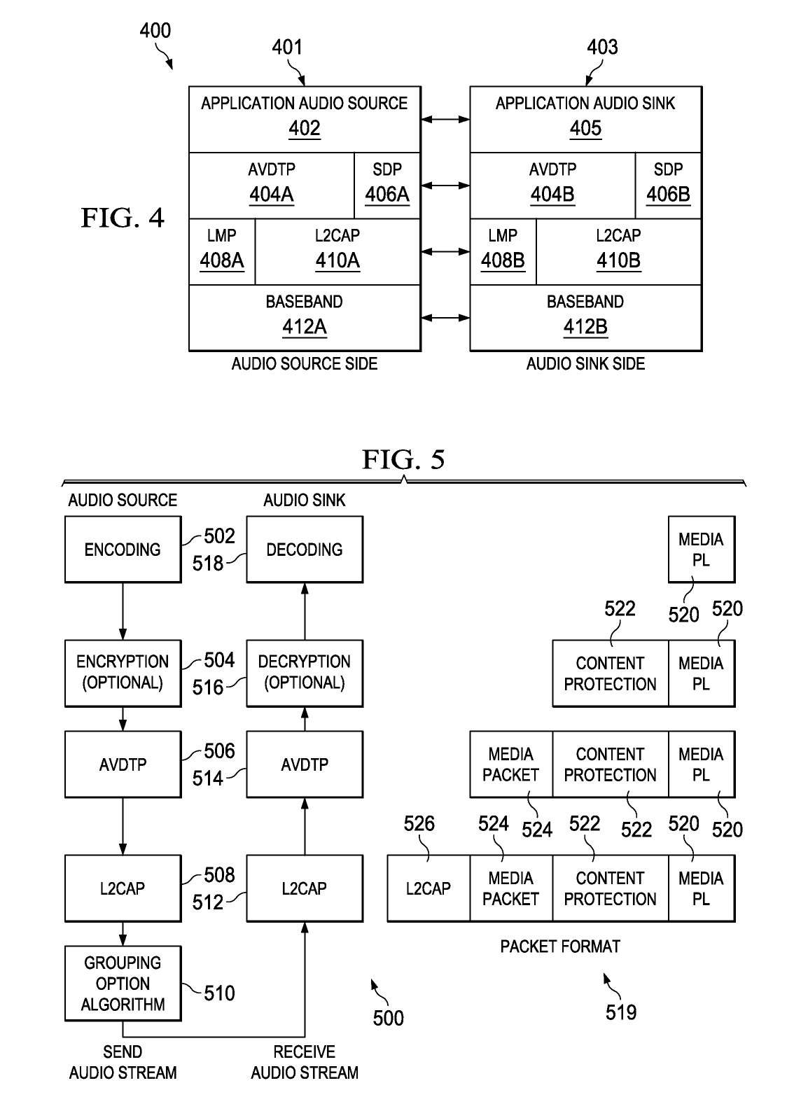

FIG. 4 illustrates a protocol model 400 in accordance with an embodiment of the disclosure. The protocol model 400 of FIG. 4 corresponds to data streaming protocols implemented with an audio source side 401 having an application audio source 402 and with an audio sink side 403 having an application audio sink 405. The baseband protocols 412A and 412B, the LMP protocols 408A and 408B, the L2CAP protocols 410A and 410B, the SDP protocols 406A and 406B and the AVDTP protocols 404A and 404B are defined in Bluetooth® core specifications. In at least some embodiments, a grouping option algorithm as disclosed herein is applied to the protocol model 400. More specifically, the grouping option algorithm described herein may be implemented within or above protocol 410A in model 400. It is also possible to include the grouping option algorithm as part of the baseband protocol 412A, in which case re-grouping may be needed. In alternative embodiments, other protocol models may be the basis for a grouping option algorithm.

FIG. 5 illustrates a block diagram 500 of data streaming procedures and packet format layering 519 in accordance with the protocol model 400 of FIG. 4. In FIG. 5, the block diagram 500 comprises various steps performed by an audio source and by an audio sink. The audio streaming procedure of block diagram 500 comprises an audio source performing an encoding step 502, an optional encryption step 504, an AVDTP step 506 and an L2CAP step 508. Further, the audio streaming procedure shown in block diagram 500 comprises an audio sink performing an L2CAP step 512, an AVDTP step 514, an optional decryption step 516 and a decoding step 518. As shown in FIG. 5, the audio streaming procedure of block diagram 500 also comprises a grouping option algorithm step 510 to perform the grouping option algorithm disclosed herein. In at least some embodiments, the grouping option algorithm step 510 is performed on the audio source side after the L2CAP step 508. Alternatively, the grouping option algorithm step 510 may be performed on the audio source side before or within the L2CAP step 508. In some embodiments, the grouping option algorithm step 510 is performed between the audio source side and the audio sink sides (e.g., by data grouping logic between the audio source and the audio sink as in FIG. 2).

The packet format layering 519 changes as streaming data proceeds through the audio streaming procedure of block diagram 500. More specifically, a media payload (PL) 520 is initially output from the encoding step 502. If the encryption step 504 is performed, a content protection (CP) header 522 is added to the media payload. At the AVDTP step 506, a media packet header 524 is added to the output of the optional encryption step 504. At the L2CAP step 508, an L2CAP header 526 is added to the output of the AVDTP step 506. The purpose of the grouping option algorithm step 510 is to group or re-group the packets from the audio source for efficiency in a communication device with a plurality of co-existent wireless technologies (e.g., BT/WLAN). The audio sink steps of the audio streaming procedure of block diagram 500, remove the headers 526, 524, 522 until the media payload is available for decoding at decoding step 518.

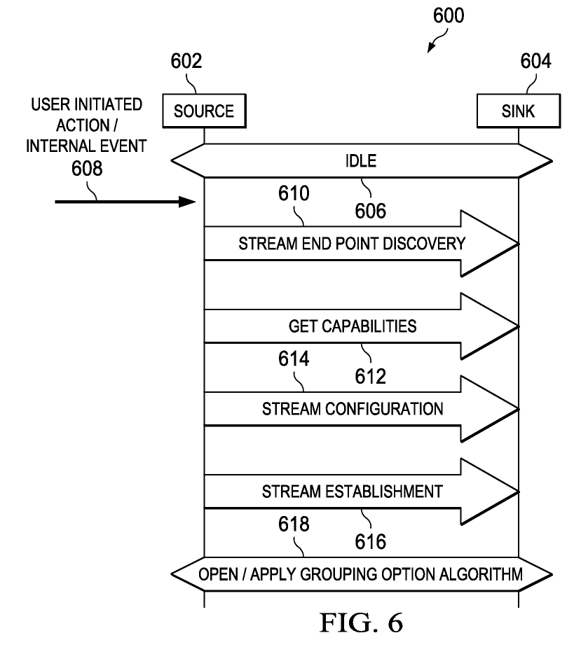

FIG. 6 illustrates a data streaming set up diagram 600 in accordance with an embodiment of the disclosure. In the diagram 600, a data source (SRC) 602 and a data sink (SNK) 604 are idle at step 606. In response to a user initiated action or internal event at step 508, the SRC 602 performs various actions including stream end point discovery of SNK 604 at step 610. The SRC 602 also determines the capabilities of SNK 604 at step 612, performs stream configuration at step 614, and established the steam at step 616. Thereafter, the SRC 602 and the SNK 604 participate in an open steaming step 618. During the open streaming step 618, the disclosed grouping option algorithm described herein can detect parameters for A2DP traffic, which can be translated into characteristics of SBC arrivals such as packet size and arrival interval.

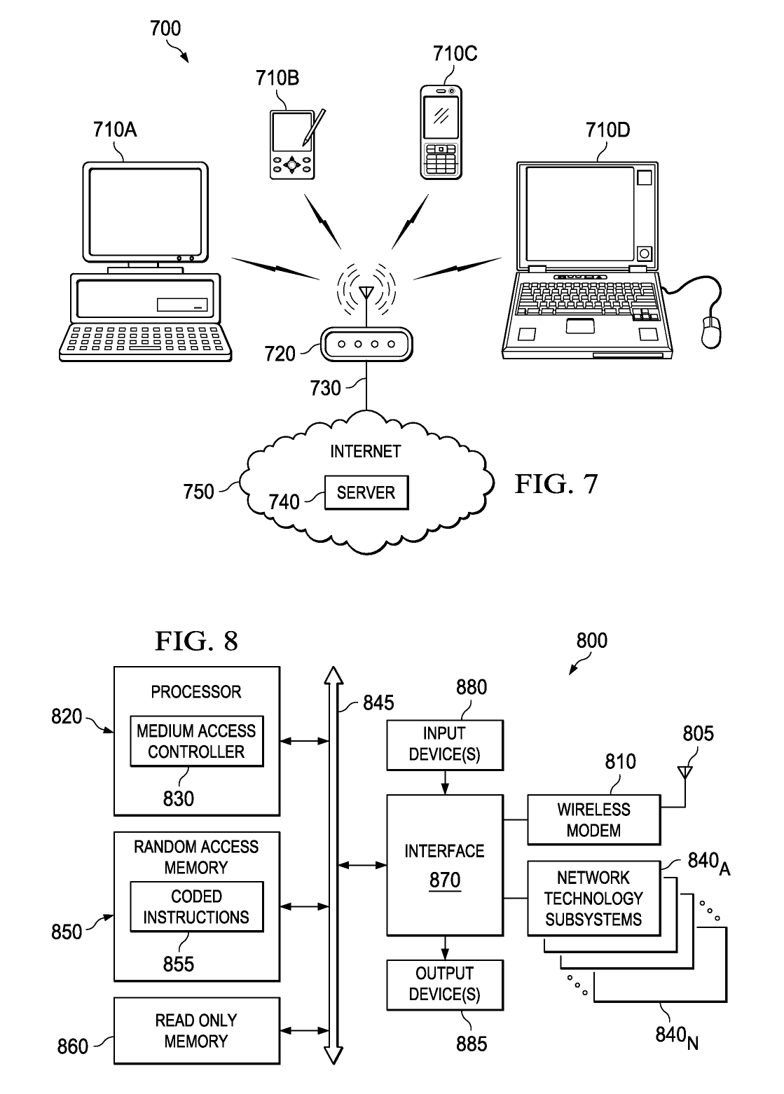

FIG. 7 illustrates a wireless local area network (WLAN) 700 in accordance with an embodiment of the disclosure. To provide wireless data and/or communication services (e.g., telephone services, Internet services, data services, messaging services, instant messaging services, electronic mail (email) services, chat services, video services, audio services, gaming services, etc.), the WLAN 700 comprises an access point (AP) 720 and any of a variety of fixed-location and/or mobile wireless devices or stations (STAs) (referred to individually herein as device, station, STA or device/station), four of which are respectively designated in FIG. 7 with reference numerals 710A, 710B, 710C and 710D. It should be appreciated that the network 700 is meant to be illustrative and not exhaustive. For example, it should be appreciated that more, different or fewer communication systems, devices and/or paths may be used to implement embodiments. Exemplary devices 710 include any variety of personal computer (PC) 710A with wireless communication capabilities, a personal digital assistant (PDA) or MP3 player 710B, a wireless telephone 710C (e.g., a cellular phone, a smart phone, etc.), and a laptop computer 710D with wireless communication capabilities. In accordance with at least some embodiments, at least one of the devices 710A-710D and 720 of WLAN 700 comprises a communication device with multiple co-existing wireless technologies onboard (referred to herein as a “combo” device).

In the example of FIG. 7, to enable the plurality of devices/STAs 710A-710D to communicate with devices and/or servers located outside WLAN 700, AP 720 is communicatively coupled via any of a variety of communication paths 730 to, for example, any of a variety of servers 740 associated with public and/or private network(s) such as the Internet 750. Server 740 may be used to provide, receive and/or deliver services such as data, video, audio, telephone, gaming, Internet, messaging, electronic mail, or other services. Additionally or alternatively, WLAN 700 may be communicatively coupled to any of a variety of public, private and/or enterprise communication network(s), computer(s), workstation(s) and/or server(s) to provide any of a variety of voice service(s), data service(s) and/or communication service(s).

In accordance with at least some embodiments, at least one of the STAs 710A-710D is a combo device that implements the disclosed grouping option algorithm. Such a combo device implements the disclosed grouping option algorithm to improve efficiency of BT communications (or another wireless protocol) and thereby increase the communication medium time allocation available for WLAN communications.

The grouping option algorithm described herein may be implemented on any general-purpose computer with sufficient processing power, memory resources, and network throughput capability to handle the necessary workload placed upon it. FIG. 8 illustrates a device 800 comprising an exemplary general-purpose computer system that may correspond to a combo device that implements the disclosed grouping option algorithm. In FIG. 8, the device 800 may be, for example, an access point or other wireless device. It should be expressly understood that any device on, for example, WLAN 700 or other embodiments, may at times be an access point and at other times be a station. It should also be understood that in some embodiments, there may be at least one dedicated access point, with any number of devices acting as stations.

As shown, the device 800 comprises at least one of any of a variety of radio frequency (RF) antennas 805 and any of a variety of wireless modems 810 that support wireless signals, wireless protocols and/or wireless communications (e.g., according to IEEE 802.11n). RF antenna 805 and wireless modem 810 are able to receive, demodulate and decode WLAN signals transmitted in a wireless network. Likewise, wireless modem 810 and RF antenna 805 are able to encode, modulate and transmit wireless signals from device 800 to other devices of a wireless network. Thus, RF antenna 805 and wireless modem 810 collectively implement the “physical layer” (PHY) for device 800. It should be appreciated that device 800 is communicatively coupled to at least one other device and/or network (e.g., a local area network (LAN), the Internet 750, or other devices). It should further be understood that illustrated antenna 805 represents one or more antennas and the illustrated wireless modem 810 represents one or more wireless modems.

The device 800 further comprises processor(s) 820. It should be appreciated that processor 820 may be at least one of a variety of processors such as, for example, a microprocessor, a microcontroller, a central processor unit (CPU), a main processing unit (MPU), a digital signal processor (DSP), an advanced reduced instruction set computing (RISC) machine, an (ARM) processor, etc. Processor 820 executes coded instructions 855 which may be present in a main memory of the processor 820 (e.g., within a random-access memory (RAM) 850) and/or within an on-board memory of the processor 820. Processor 820 communicates with memory (including RAM 850 and read-only memory (ROM) 860) via bus 845. RAM 850 may correspond to dynamic RAM (DRAM), synchronous dynamic RAM (SDRAM), and/or any other type of RAM device. ROM 860 may correspond to flash memory and/or any another type of non-volatile memory device.

Processor 820 implements medium access controller (MAC) 830, which provides MAC functionality and further implements, executes and/or carries out functionality to facilitate, direct and/or cooperate in implementing the grouping option algorithm disclosed herein. The MAC 830 is implemented by executing one or more of software, firmware, processing thread(s) and/or subroutine(s) with the example processor 820. Further, the MAC 830 may be, additionally or alternatively, implemented by hardware such as an application specific integrated circuit (ASIC), a programmable logic device (PLD), a field programmable logic device (FPLD), discrete logic, etc.

The device 800 also preferably comprises at least one input device 880 (e.g., keyboard, touchpad, buttons, keypad, switches, dials, mouse, track-ball, voice recognizer, card reader, paper tape reader, etc.) and at least one output device 885 (e.g., liquid crystal display (LCD), printer, video monitor, touch screen display, a light-emitting diode (LED), etc.)—each of which are communicatively connected to interface 870.

As shown, interface 870 also communicatively couples a wireless modem 810 with the processor 820. Interface 870 provides an interface to, for example and not by way of limitation, Ethernet cards, universal serial bus (USB), token ring cards, fiber distributed data interface (FDDI) cards, network interface cards, wireless local area network (WLAN) cards, or other devices that enable device 800 to communicate with other devices and/or to communicate via Internet 750 or intranet. With such a network connection, it is contemplated that processor(s) 820 would be able to receive information from at least one type of network technology and/or output information to at least one type of network technology in the course of performing the herein-described processes. It should be appreciated that interface 870 may implement at least one of a variety of interfaces, such as en external memory interface, serial port, communication internal to device 800, general purpose input/output (I/O), etc.

As shown in FIG. 8, the device 800 comprises network technology subsystems 840_{A}-840_{N}, where N is the number network technology subsystems in device 800. In accordance with embodiments, device 800 comprises at least two dissimilar network technology subsystems 840. As a result, device 800 is said to have co-existing network technologies. “Dissimilar” is used in this context to mean that at least one of the subsystems 840 is from a different network technology than another one of the subsystems 840. Thus, it should be understood that some embodiments of subsystems 840 may have their own dedicated wireless modem and antenna, while other embodiments may share either or both of a wireless modem and antenna. Examples of network technologies that may be represented by such subsystems include, but are not limited to, worldwide interoperability for microwave access (WiMAX) networks, wireless local area network (WLAN) networks, long term evolution (LTE) mobile telephony networks, personal area networks (PANs), wireless universal serial bus (USB) networks, BLUETOOTH (BT) networks, ZigBee/IEEE 801.15.4, etc. In accordance with embodiments, processor 820 interacts with network technology subsystems 840 via interfaces implemented by interface 870. It should be appreciated that, for the ease of illustration, only two or three of such network technologies may be discussed in connection with any particular embodiment. However, the grouping option algorithm techniques described herein apply equally to devices having other wireless technology combinations onboard a device.

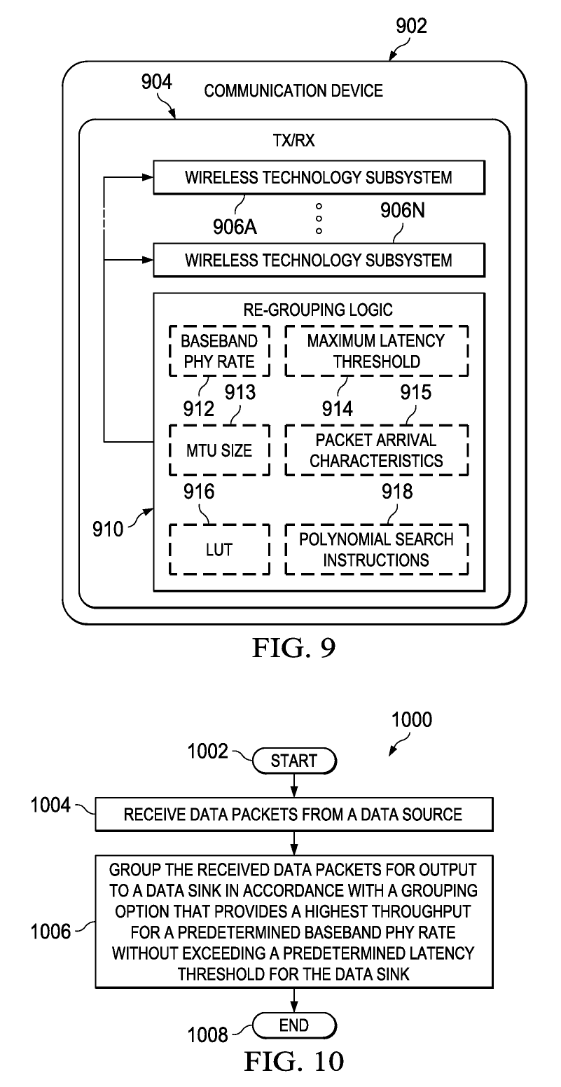

FIG. 9 illustrates a simplified communication device 902 in accordance with an embodiment of the disclosure. The communication device 902 is representative of a combo device as described herein. As shown, the communication device 902 comprises a transceiver (TX/RX) 904 having a plurality of wireless technology subsystems 906A-906N. At least two of the wireless technology subsystems 906A-906N operate at relatively close or overlapping frequency bands with respect to each other such that time-multiplexing is implemented to avoid co-existence interference. Further, the transceiver 904 comprises re-grouping logic 910 to implement the grouping option algorithm disclosed herein. The re-grouping logic 910 enables the transceiver 904 to receive non-optimized groupings of data packets and to optimize the groupings for transmission to a data sink.

In at least some embodiments, the re-grouping logic 910 stores or has access to a baseband PHY rate 912, a maximum latency threshold 914, an MTU size 913 and packet arrival characteristics 915. As previously discussed, the baseband PHY rate 912, the maximum latency threshold 914, the MTU size 913 and the packet arrival characteristics 915 may vary for different applications (e.g., different data streaming procedures). To perform the grouping operations described herein, the re-grouping logic 910 accesses LUT 916 or optionally executes polynomial search instructions 918. For example, if the LUT 916 does not enable selection of a grouping option, then the polynomial search instructions 918 may be executed to determine an optimal grouping option according to parameters such as the baseband PHY rate 912, the maximum latency threshold 914, the MTU size 913 and/or packet arrival characteristics 915.

FIG. 10 shows a method 1000 for a processor (e.g., a host processor or a transceiver processor) in accordance with an embodiment of the disclosure. As shown, the method 1000 starts at block 1002 and continues by receiving data packets from a data source (block 1004). The received data packets are grouped for output to a data sink in accordance with a grouping option that provides a highest throughput for a predetermined baseband PHY rate, MTU size, and packet arrival characteristics without exceeding a predetermined latency threshold for the data sink (block 1006) and the method 1000 ends at block 1008. In at least some embodiments, the grouping step 1006 determines the grouping option by accessing an LUT of grouping options. Additionally or alternatively, the grouping step 1006 determines the grouping option by performing a polynomial search of grouping options. As an example, the grouping step 1006 may determine a maximum number of low complexity sub-band codec (SBC) frames to package into an L2CAP frame without exceeding a predetermined latency threshold of a data sink.

Many modifications and other embodiments of the invention will come to mind to one skilled in the art to which this invention pertains having the benefit of the teachings presented in the foregoing descriptions, and the associated drawings. For example, the Therefore, it is to be understood that the invention is not to be limited to the specific embodiments disclosed. Although specific terms are employed herein, they are used in a generic and descriptive sense only and not for purposes of limitation.

What is claimed is:

1. A communication device, comprising:
a host processor;
a plurality of co-existing wireless technology transceivers coupled to the host processor, wherein the plurality of co-existing wireless technology transceivers share a communication medium using time-multiplexing;
wherein a throughput for data transmissions by the plurality of co-existing wireless technology transceivers is based on an algorithm that determines a grouping option for data packets to be transmitted by one of the co-existing wireless technology transceivers, the grouping option providing a highest throughput for a predetermined baseband PHY rate without exceeding a predetermined maximum grouping delay.

2. The system of claim 1 wherein the algorithm enables a non-optimized grouping of data packets to be replaced with an optimized grouping of data packets for transmission by a first co-existing wireless technology transceiver and enables a time allocation of the communication medium to a second co-existing wireless technology transceiver to be increased.

3. The system of claim 2 wherein the first co-existing wireless technology transceiver is a Bluetooth® transceiver and the second co-existing wireless technology transceiver is a wireless local area network (WLAN) transceiver.

4. The system of claim 1 wherein the algorithm is executed by the host processor and wherein the host processor outputs optimized groupings of the data packets in accordance with the algorithm for transmission by one of the co-existing wireless technology transceivers.

5. The system of claim 1 wherein the algorithm is executed by one of the co-existing wireless technology transceivers and wherein the co-existing wireless technology transceiver that executes the algorithm is configured to receive a non-optimized grouping of the data packets from the host processor and to re-group the data packets in accordance with the algorithm.

6. The system of claim 1 wherein the algorithm employs a look-up-table (LUT) to determine said grouping option.

7. The system of claim 1 wherein the algorithm performs a polynomial search to determine said grouping option.

8. The system of claim 1 wherein the algorithm is applied to A2DP traffic output by the host processor for transmission by one of the co-existing wireless technology transceivers.

9. The system of claim 1 wherein the algorithm determines a maximum number of low complexity sub-band codec (SBC) frames to package into an L2CAP frame without exceeding the predetermined maximum grouping delay.

10. The system of claim 1 wherein the predetermined maximum grouping delay is based on a minimum latency requirement of a data sink that receives groupings of data packets from one of the co-existing wireless technology transceivers.

11. A transceiver, comprising:
receiving logic configured to receive data packets from a data source; and
re-grouping logic configured to re-group the received data packets for output to a data sink,
wherein the re-grouping logic determines a grouping option that provides a highest throughput for a predetermined baseband PHY rate without exceeding a predetermined latency threshold for the data sink.

12. The transceiver of claim 11 wherein, if the receiving logic receives A2DP traffic from the data source, the re-grouping logic determines a maximum number of low complexity sub-band codec (SBC) frames to package into an L2CAP frame without exceeding the predetermined latency threshold.

13. The transceiver of claim 11 wherein the re-grouping logic determines if a re-grouping benefit is greater than a re-grouping overhead prior to re-grouping the received data packets.

14. The transceiver of claim 11 wherein the predetermined latency threshold is selected to be slightly less than a pre-buffering time of the data sink.

15. The transceiver of claim 11 wherein the re-grouping logic employs a look-up-table (LUT) to determine said grouping option, the LUT storing a baseband PHY rate, a maximum transmission unit (MTU) size, a sub-band codec (SBC) frame size and maximum grouping latency.

16. The transceiver of claim 11 wherein the re-grouping logic performs a polynomial search to determine said grouping option, said polynomial search determines a maximum throughput for grouping options within a search space defined by a baseband PHY rate value, a maximum transmission unit (MTU) size, a sub-band codec (SBC) frame size and maximum grouping latency.

17. A method, comprising:
receiving, by a processor, data packets from a data source; and
grouping, by the processor, the received data packets for output to a data sink,
wherein said grouping comprises determining a grouping option that provides a highest throughput for a predetermined baseband PHY rate without exceeding a predetermined latency threshold for the data sink.

18. The method of claim 17 wherein said grouping determines a maximum number of low complexity sub-band codec (SBC) frames to package into an L2CAP frame without exceeding the predetermined latency threshold.

19. The method of claim 17 wherein said determining a grouping option comprises accessing a look-up-table (LUT) of grouping options.

20. The method of claim 17 wherein said determining a grouping option comprises performing a polynomial search.
